(19) United States
(12) Patent Application Publication
(10) Pub. No.: US 2015/0111187 A1
(43) Pub. Date: Apr. 23, 2015

(54) SYSTEM AND METHOD FOR PROVIDING A CLIENT ENGAGEMENT PLATFORM TO ASSIST A CLIENT IN THE COMPLIANCE OF ADDICTION TREATMENT

(71) Applicants: Peter K. Loeb, JR., Redwood City, CA (US); Ashley W. Loeb, Huntington Beach, CA (US)

(72) Inventors: Peter K. Loeb, JR., Redwood City, CA (US); Ashley W. Loeb, Huntington Beach, CA (US)

(21) Appl. No.: 14/496,352

(22) Filed: Sep. 25, 2014

Related U.S. Application Data
(60) Provisional application No. 61/893,176, filed on Oct. 19, 2013.

(51) Int. Cl. H04L 29/08; G09B 19/00; G06Q 10/10

(52) U.S. Cl. CPC H04L 67/22; H04L 67/18; G06Q 10/1095; G09B 19/00
USPC 434/236

(57) ABSTRACT

A method is provided for providing a client engagement platform to assist a client in the compliance of addiction treatment. The method is implemented in a central system programmed to execute the method. The method comprises storing, in the central system, a schedule in which one or more designated check-in times are associated with one or more client daily activities and receiving, by the central system, a client check-in.

### CROSS-REFERENCE TO RELATED APPLICATIONS

The application claims priority to U.S. provisional application Ser. No. 61/893,176, filed Oct. 19, 2013, which is incorporated by reference herein.

### FIELD OF THE INVENTION

The present invention relates to a system and method for providing a client engagement platform to assist a client in the compliance of addiction treatment.

### BACKGROUND OF THE INVENTION

Addiction is a serious problem in the U.S. There are many types of addictions. Examples include alcohol, Oxycontin, opiates, cocaine, food and sex (to name a few). Roughly seven percent of the U.S. population, i.e., approximately twenty-three million people, struggle with addiction at a cost of $450 million. Professional treatment generally involves four levels of care (i.e., therapies), each of which consists of various therapy groups, individual treatment sessions and other activities. These levels are residential treatment, partial hospitalization, intensive outpatient, and outpatient.

With residential treatment, an addict must submit to in-patient long term or short term overnight stays. Partial hospitalization requires an addict to adhere to a series of all-day treatment sessions within a hospital setting. Intensive outpatient treatment requires an addict to comply with a thirty-six hour per month treatment plan, typically including several multi-hour sessions weekly. Outpatient treatment requires an addict to attend several outpatient appointments that are scheduled over a defined period of time (e.g., month). During outpatient treatment, an addict must submit to periodic drug testing. Typically, testing is performed through either a “qualitative” screening, which produces a result within a few minutes, or a “quantitative” test, which requires sending a specimen to a laboratory for analysis. These tests may use blood, urine, hair, fingernails, or saliva as a specimen. The addict is subject to camera inspection or observation while the specimen is collected. With any treatment modality, daily structure and accountability are essential for the treatment to be effective.

While the standard treatment options above have been adequate to treat addiction, only eleven percent seek professional treatment. There are several reasons for this. First, standard treatment options are quite costly. Second, treatment is not always available in various parts of the U.S for every addict. Third, there is a significant stigma to seeking treatment. For those who actually seek treatment, daily schedule compliance is difficult to achieve. Addicts may forget or avoid therapy appointments.

It would thus be advantageous to provide a system and method that will overcome the problems described above.

### SUMMARY OF THE INVENTION

In accordance with an embodiment of the present disclosure, a system and method are disclosed for providing a client engagement platform to assist a client in the compliance of addiction treatment.

In accordance with an embodiment of the present disclosure, a method is disclosed for providing a client engagement platform to assist in behavior modification, wherein the method is implemented in a central system programmed to execute the method, the method comprising storing, in the central system, a schedule in which one or more designated check-in times are associated with one or more client daily activities and receiving, by the central system, a client check-in.

In accordance with another embodiment of the present disclosure, a computer-implemented system is disclosed for providing a client engagement platform to assist a client in the compliance of addiction treatment, the system including a central system comprising a data storage to store, a client account database, wherein information pertaining to a client is stored in the client database; and a client schedule database, wherein information pertaining to a schedule of a client is stored in the client schedule database and wherein each schedule includes a plurality of check-in times associated with a plurality of client daily activities, and one or more servers coupled to the data storage, wherein the one or more servers comprise one or more processors configured to execute computer program steps, the steps comprising: receiving a client check-in, processing the client's check-in and storing the client check-in.

In accordance with another embodiment of the present disclosure, a computer-implemented system is disclosed for providing a client engagement platform to assist a client in the compliance of addiction treatment, the system comprising: a data storage to store a client account database, wherein information pertaining to a plurality of client accounts are stored in the client account database a client schedule database, wherein information pertaining to plurality of schedules of a plurality of clients are stored in the client schedule database and wherein each schedule includes a plurality of check-in times associated with a plurality of client daily activities and a client group database, wherein information relating to at least one group of clients are stored and wherein clients in the at least one group are associated with each other for support, messaging and/or social networking activities and one or more servers coupled to the data storage, wherein the one or more servers comprise one or more processors configured to execute computer program steps, the steps comprising: receiving a client check-in, processing the client check-in and storing the client check-in.

In accordance with another embodiment of the present disclosure, a method is disclosed for providing a client engagement platform to assist a client in the compliance of addiction treatment comprising in response to a client request, accessing a client schedule via an application on a computing device, wherein the client schedule being accessed from a central system over a network and wherein the client schedule includes a one or more check-in times associated with a plurality of client daily activities, initiating a client check-in from the client schedule via the application on the mobile device or a personal computer, receiving data pertaining to the client check-in by a predefined time within the one or more check-in times via the application on the mobile device or a personal computer, and sending the data over the network from the mobile device or personal computer to the central system to acknowledge the client check-in.

In accordance with another embodiment of the present disclosure, a computer readable medium is disclosed for storing at least one computer program for providing a client engagement platform to assist a client in the compliance of addiction treatment, the at least one computer program comprising instructions, which when executed by a mobile device or a personal computer, cause the mobile device or personal computer to receive data pertaining to the client check-in by a predefined time within the one or more check-in times via the application on the mobile device or a personal computer and send the data over the network from the mobile device or personal computer to the central system to acknowledge the client check-in.

### BRIEF DESCRIPTION OF THE DRAWINGS

FIG. 1 depicts a block of an example system for providing a client engagement platform to assist the client in compliance of addiction treatment.

FIG. 2 depicts a block diagram of the central system shown in FIG. 1 in which several databases and software applications/modules are shown.

FIG. 3 depicts a flowchart of an example application process of the system in FIG. 1 in which a counselor creates a client account and schedule.

FIGS. 4A-4B depict a flowchart of an example application process of the system in FIG. 1 in which a check-in is performed.

FIG. 5 depicts a flowchart of an example application process of the system in FIG. 1 in which a counselor views a client schedule.

FIG. 6 depicts a block diagram of the components within a mobile device shown in FIG. 1.

FIG. 7 depicts a general-purpose computer to support the embodiments of the computer-implemented systems and methods including computer components disclosed in this application.

FIGS. 8-18 depict several examples of various user interfaces for the application process of the system in FIG. 1.

### DETAILED DESCRIPTION OF THE INVENTION

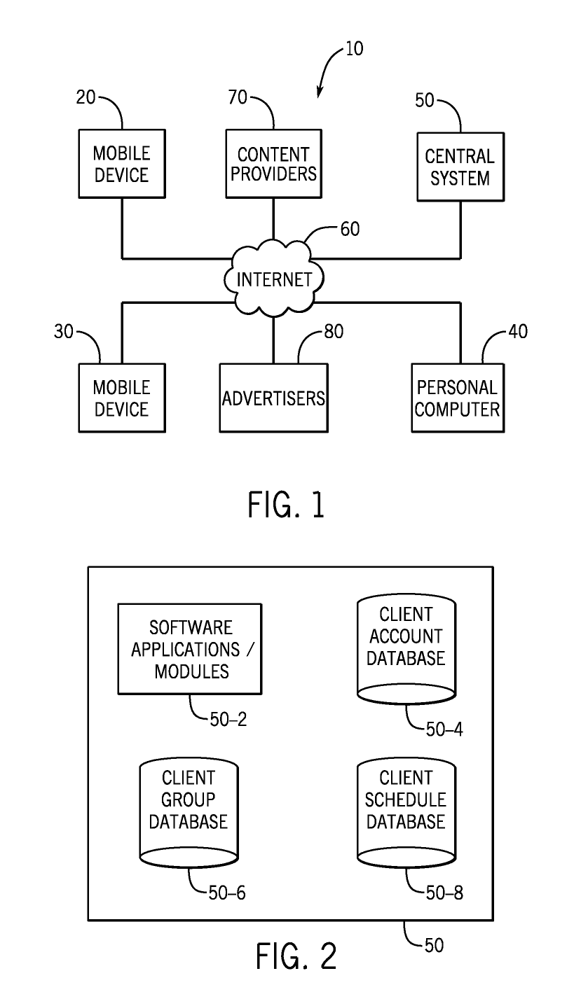

FIG. 1 depicts a block of an example system 10 for providing a client engagement platform to assist a client in the compliance of addiction treatment or assist a client in any other behavior modification. A client may be a user or person who struggles with an addiction or desires to modify or change any other behavior (also referred to as behavior modification). The addiction may be chemical substances (drugs and alcohol) or other “process addictions” (comprising extreme or obsessive behavior). For purposes of the client engagement platform described in this disclosure, the client employs the services of, i.e., seeks treatment from a counselor (professional) for his/her addiction. (A counselor includes a therapist or other user such as the counselor's administrative staff that assists the counselor in the treatment of the client.) However, the client may employ the services of non-professionals for addiction treatment and the client engagement platform described herein. Examples of non-professionals include a coach, sponsor, a peer (of a client peer group) or even the client him/herself (or other user). That is, a peer in a client peer group may schedule client check-ins and/or feedback with respect to the platform. This is described in more detail below.

System 10 includes mobile devices 20, 30, central system 50 and content providers 70. Mobile devices 20, 30 and personal computer 40 are connected to central system 50 and content providers 70 via a communication network such as Internet 60 as known to those skilled in the art. Clients use mobile devices 20, 30 or personal computer 40 to access applications and information locally within the devices and personal computer or remotely on central system 40 via a web browser or stand alone application on mobile devices 20, 30 or personal computer 40 as described in more detail below.

Examples of the content providers 70 include news sources, aggregators and social networking websites (e.g., Linkedln and Facebook). Examples of mobile devices 20, 30 as described herein include smartphones (e.g., iPhones, Android phones), cell phones, tablets (e.g. iPads), laptop, PDAs and other devices. Personal computer is a desktop computer as known to those skilled in the art. Mobile devices 20, 30 will enable a user (e.g., client, counselor and/or other) to communicate wirelessly with and access content from central system 50 or other systems if desired, over Internet 60 through carrier networks (e.g., Verizon, Sprint, T-Mobile, AT&T) or available WIFI networks as known by those skilled in the art or communicate by wire as known to those skilled in the art). Personal computer 40 also enables a user (e.g., client, counselor and/or other) to communicate with central system 50 (or other system) over Internet 60 via cable, ISDN, WIFI or wireless carrier networks as known to those skilled in the art. (The carrier networks and WIFI networks described above are not shown in FIG. 1.) Two mobile devices and one personal computer are shown for illustrative purposes, but those skilled in the art know that any number of mobile devices or personal computers may be used for any number of clients and counselors (users). Central system 50 is configured to facilitate the provision of targeted content from content providers 70 to clients via mobile devices 20, 30 and/or personal computer 40 as known to those skilled in the art. System 10 further includes advertisers 80. Central system 50 is also configured to facilitate the provision of targeted advertisements from advertisers 80 to clients via mobile devices 20, 30 and personal computer 40 as known to those skilled in the art.

As described in more detail below, central system 50 includes one or more servers including a web server. Each server includes several internal components, databases, software modules and applications as known to those skilled in the art. This is described in more detail below. System 10 is used to implement the application processes discussed herein.

FIG. 2 depicts a block diagram of central system 50 shown in FIG. 1 in which several databases and software modules/applications are shown. In particular, several applications/modules 50-2 including one or more applications that form part of the engagement platform to assist a client in the compliance of addiction treatment (as discussed below) are stored in memory. In addition, central system 50 further includes a client (user or patient) account database wherein client account data (information) is stored. Such data includes client name and address and possibly addiction type, prior treatment plans, medical information, family history and/or any other information that complies with HIPAA or other laws. Central system 50 further includes client therapy group database 50-6, each of which has a number of clients that are connected to or associated with each other for support, messaging and other social activities. (These groups may be lead by a counselor (professional), sponsor, coach, or client peers (users that are members of a group). Central system 50 incorporates a platform for enabling such confidential social networking activities as known to those skilled in the art. Client may access via a social networking website or portal via a mobile device or personal computer as known to those skilled in the art. (Alternatively, networking may be accomplished via third party social networking sites (e.g., Facebook) if confidentiality is not a concern.)

Central system 50 also includes client schedule database 50-8 wherein one or more client schedules are organized and stored. As shown in FIG. 2, three databases are shown, but those skilled in the art know data organized and stored in databases 50-4 through 50-8 may be organized and stored in one, two or more databases. The databases 50-4, 50-6 and 50-8 are also part of the engagement platform to assist a client in the compliance of addiction treatment.

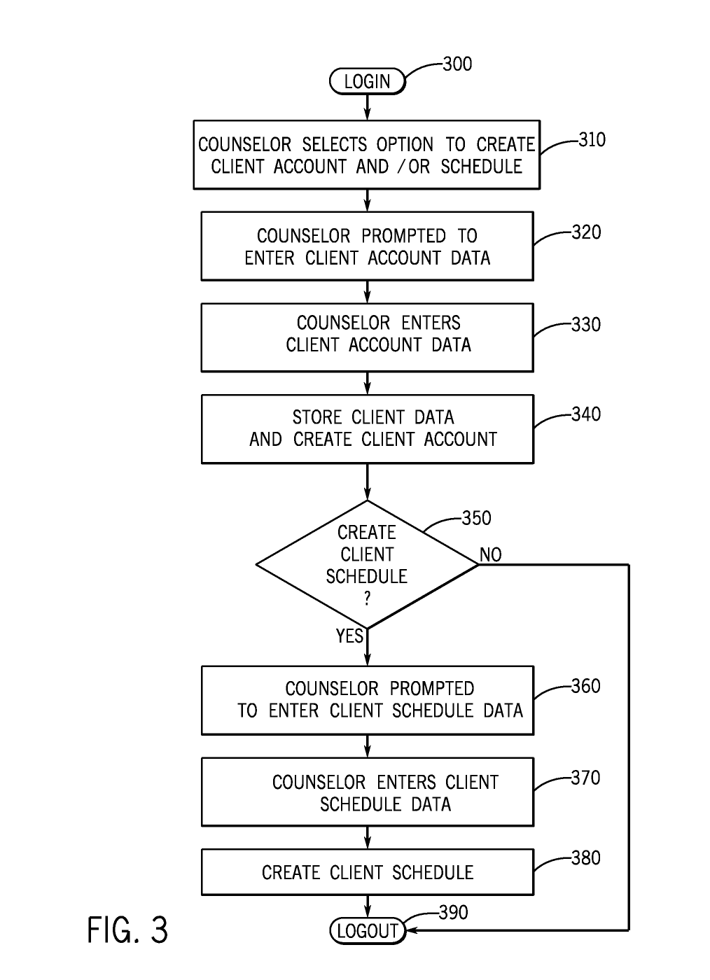

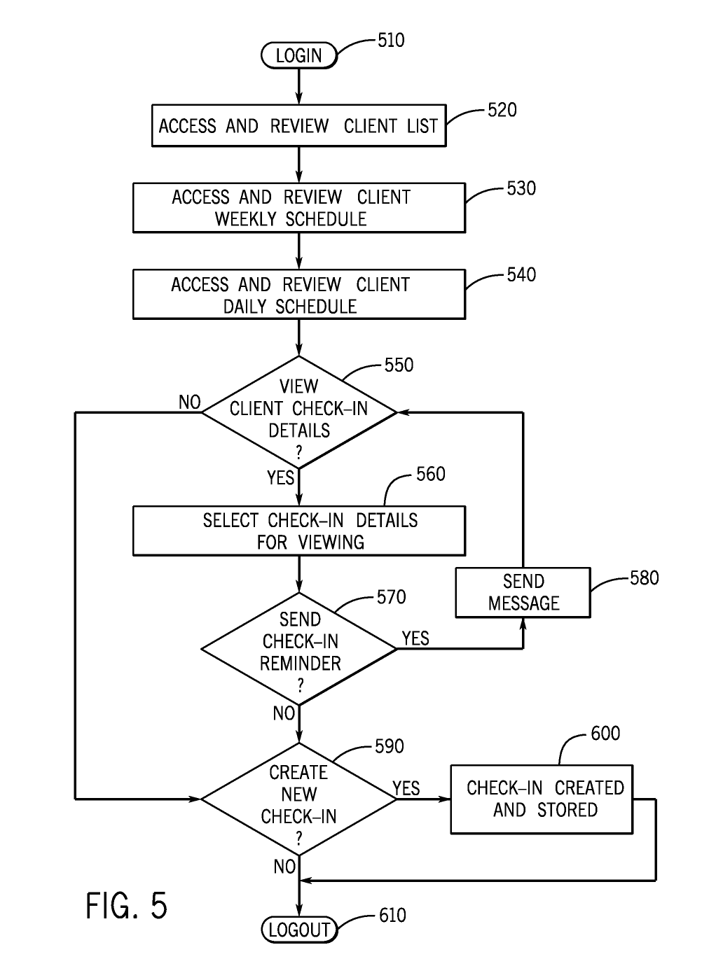

FIG. 3 depicts a flowchart of the application process of system 10 in FIG. 1 in which a counselor creates a client account and/or schedule. Specifically, the process begins at step 300 wherein a counselor performs a login. The counselor has the option to select a process to create a new client account and/or schedule. (There exists other options not shown in FIG. 3 such as the option to view a client schedule and check-in activity. This is shown in FIG. 5 and described in corresponding section below.) If the counselor selects the option to create an account and schedule at step 310, the process then moves to step 320 wherein the counselor is prompted to enter client account data at step 330. Next, the counselor will enter client data to create an account at step 330 and such account is created and stored at step 340.

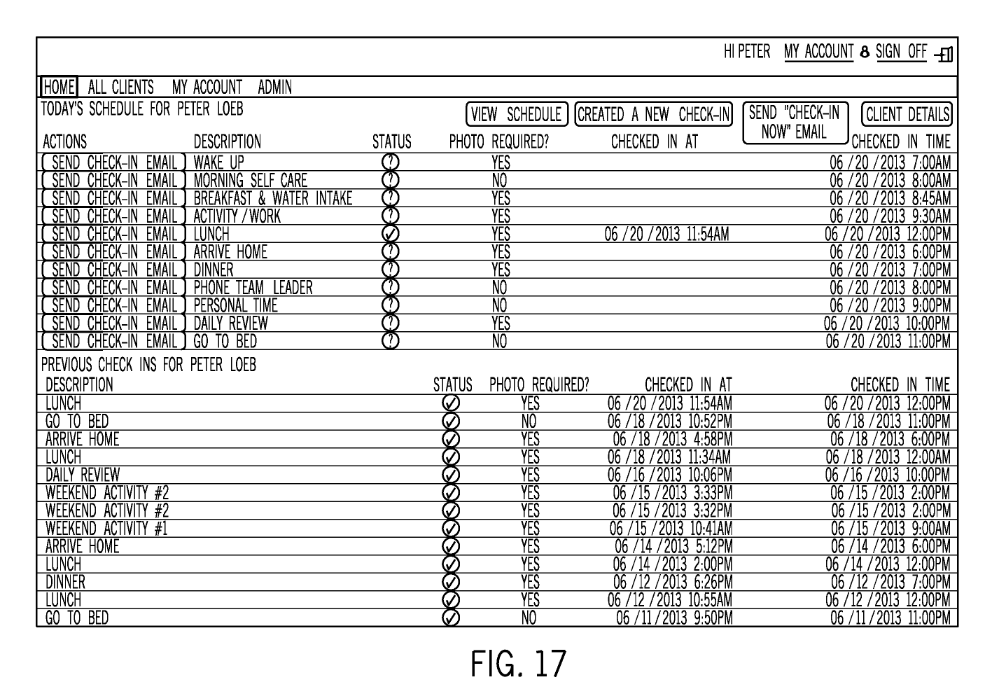

Now, the process moves to decision step 350 wherein the counselor decides whether to create a schedule for the client. If not, the process moves to 390 wherein the user performs a logoff or alternatively is logged off automatically. If the counselor decides to create a schedule, the process moves to step 360 wherein the counselor is prompted to enter a client schedule data via an application interface or browser (through a mobile device or a personal computer). At step 370 the counselor actually enters client schedule data. The data will be comprise activities and designated times for such activities. For example, the counselor may enter a check-in times for “wake up,” “Breakfast & Water Intake,” “Activity/Work.” The counselor will also enter check-in times associated with other activities. (See FIGS. 9 and 17 wherein a list of activities of a client schedule is shown). The counselor will, in live consultation with the client via video conference or phone call, create the schedule for the client. Importantly, the counselor will enter sufficient data to create a schedule with full daily structure for the client (patient/user). A full daily structure or routine is necessary for treatment to improve recovery outcomes. At step 380, a schedule is created. In practice, a counselor or his/her administrative staff may create a client account. The counselor performs a logoff at step 390. As shown in FIG. 3 and described above, a counselor is involved in client account and schedule creation. However, as described above, a counselor (professional) is not required to perform these tasks. Those skilled in the art know that any person can perform such tasks such as a coach, sponsor, client or other person/user approved by a client.

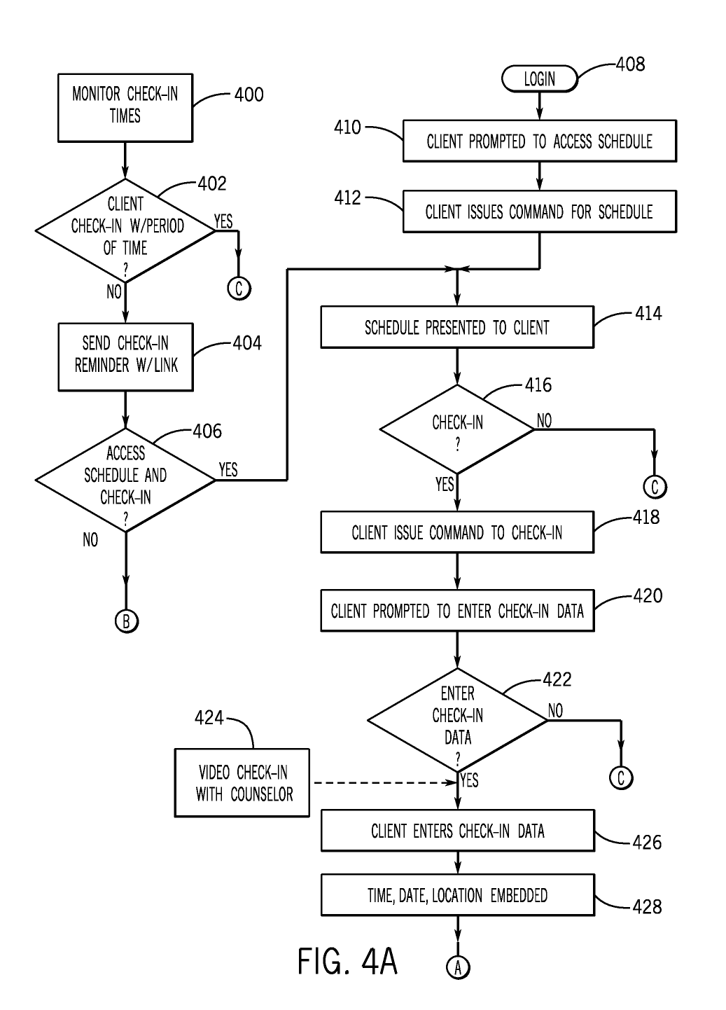

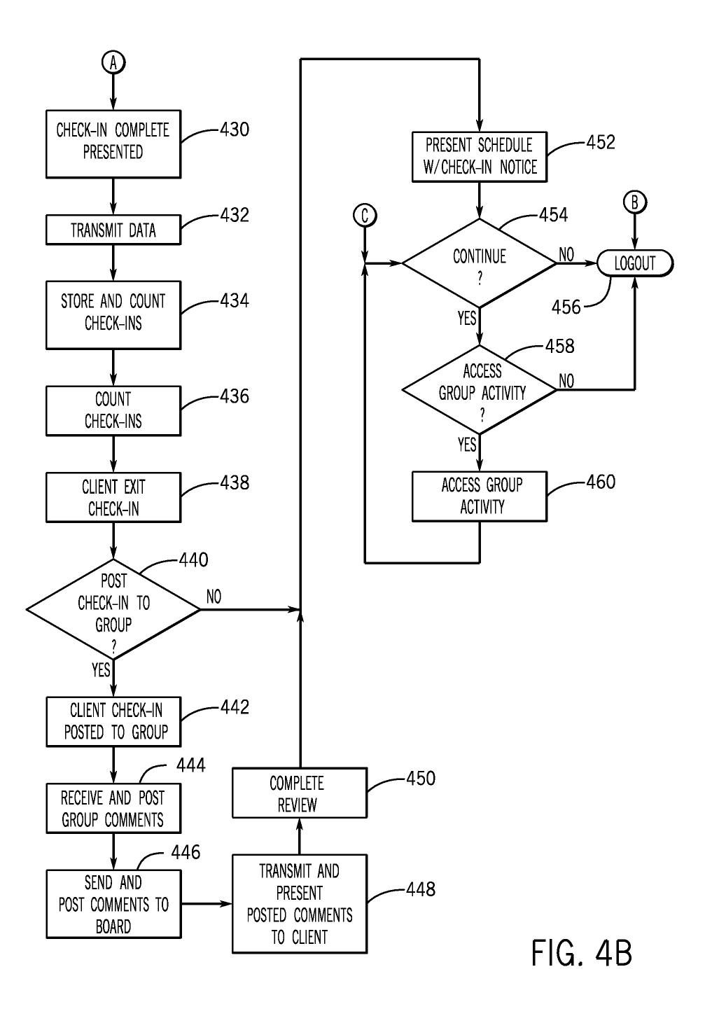

FIGS. 4A-4B depicts a flowchart of the application process of system 10 in FIG. 1 in which a check-in is performed. In this application process, there are essentially two ways in which a client may access his/her own schedule for performing a check-in. A client may either (1) activate a web link in a received reminder message or (2) initiate a login to access his/her own schedule. The process operates in the background whether or not a client has actually performed a login.

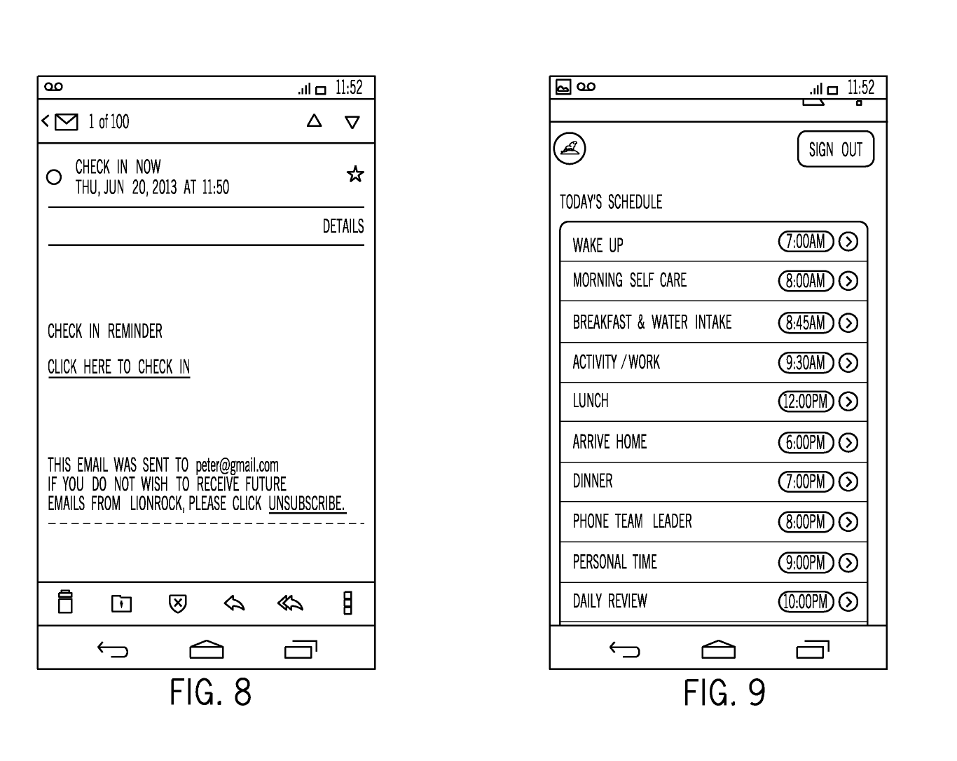

Referring to FIGS. 4A-4B, the process monitors check-in times and determines whether the client has checked-in within a predefined time period before the designated check-in time listed in the client schedule at steps 400 and 402, respectively. The predefined time period may be set to be 10 minutes prior to check-in time or any other desired period of time. If the client has checked-in by the predefined time period, the process moves to step 454 as described below. If the client has not checked-in by predefined time period, central system 50 sends a check-in reminder message to the client at step 404 in which a web link enables the client to access his/her own schedule for performing a check-in. FIG. 8 depicts an example of such a reminder message incorporating a web link. The reminder message in FIG. 8 is an email but a reminder message may be by text or other messaging medium known to those skilled in the art. The client then has a choice whether to activate the link and check-in at step 406. If the client does not wish to check-in, the process may logout at step 456. If the client decides to check-in, the client activates (clicks) the link at step 408 and the process moves to step 414 wherein the client is presented with his/her schedule. In this embodiment, access to the client schedule is executed without a login but in alternative embodiments, a login may be required when the web link is activated.

Alternatively, the client may access his/her own schedule by initiating a login without any reminder message. In this respect, the process begins when a client (patient/user) performs a login at step 408. Login may be achieved through a dedicated application or web browser. The process moves to step 410 wherein the client is then prompted to access his/her schedule created by the counselor and the client issues a command for accessing such schedule at step 414. The client schedule is presented at step 414 (as it appears for the client if he/she activates a the web link in a reminder message). FIG. 9 depicts an example of a client schedule with a list of several daily activities and associated check-in times.

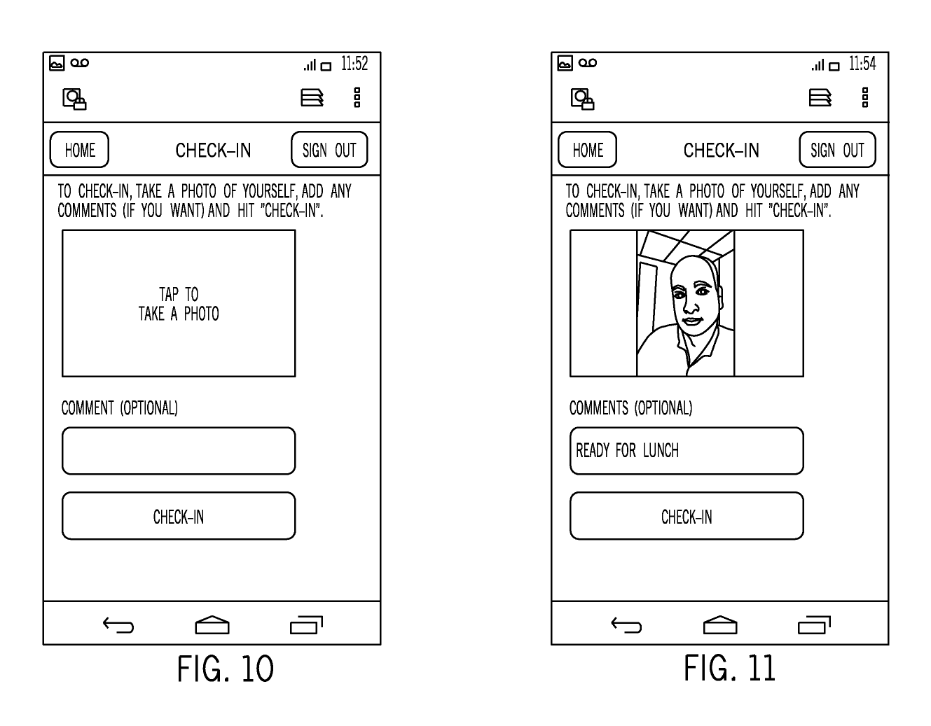

At this point, the process moves to decision step 416 wherein the client decides whether he/she wishes to check-in at a designated time. If not, the process moves to decision steps 454 as discussed in more detail below. If the client wishes to check-in, the client issues a command to check-in at the designated time slot at step 418. This may come in the form of an active button or other action known to those skilled in the art. Once the client selects an appropriate check-in time by clicking or activating a button, the client is prompted to enter check-in data via a user interface (depending on hardware used to access) at step 420. FIG. 10 depicts an example illustrating the user interface for entering data.

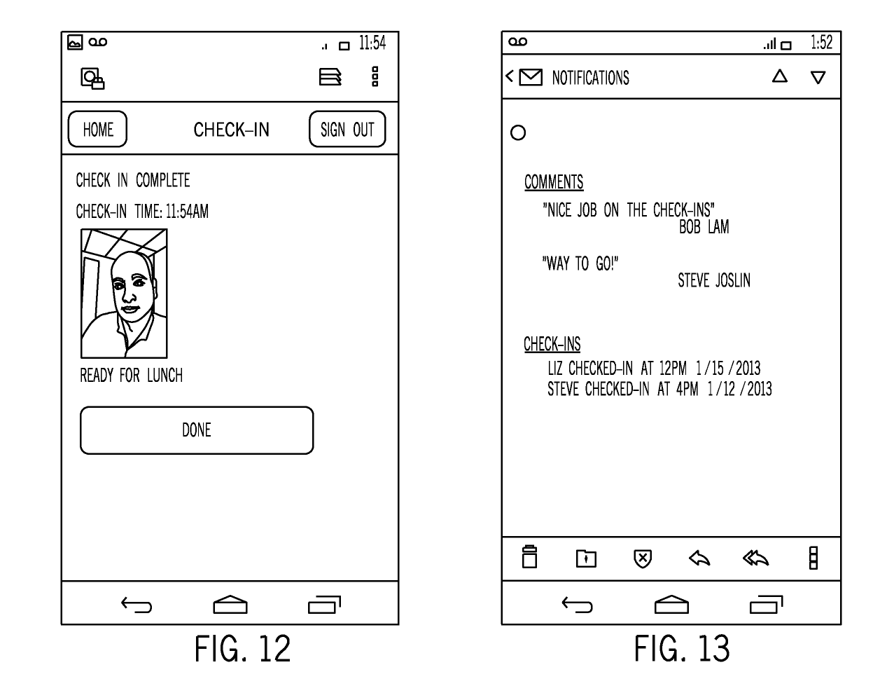

At decision step 422, the client again has the option to enter check-in data. If the client does not desire to enter data, the process moves to steps 454 as described below. If the client does wish to check-in, the client will enter check-in data into the user interface of an application or web browser on a mobile device or personal computer at step 426. In this embodiment, the data will include a photo and client personal health status. To do this, the client (user) will take a photo with a camera in the mobile device or personal computer and will make a journal entry, i.e., enter personal information about his/her personal status. The photograph (photo) is a used as verification of client status and confirm client activity at this location. That is, the photo will indicate how the client is feeling at that time and confirm that the client is actually taking action as he/she indicates. For example, if the client is required to check-in during lunch, a photo may depict the client at a restaurant and/or show the actual food or drink. These small actions or successes are important. These actions act as motivation to continue with therapy, perform all scheduled check-ins and ultimately increase the chances of long-term prognosis of behavior modification. FIG. 12 depicts an example photo as described below.

In other embodiments, those skilled in the art know that other data may be entered as desired. Check-in may optionally include a live video check-in with the counselor at step 424. FIG. 11 depicts an example of the client interface with data entered. The client may initiate a check-in by clicking “Check-In” as shown. At this point, time, date and location (by GPS using geo-fencing/location or the IP address services as known to those skilled in the art) are then automatically embedded (i.e., included) into the check-in data at step 428 to reflect a client's location, precise time of check-in and date and stored locally. In sum, data such as a photo, journal entry, geo-location, and time and date are important to motivate client adherence to therapy, thus ultimately leading to desired behavior modification.

The process moves to step 430 wherein a “Check-in Completed” notification is presented to the client. An example of this mobile interface notification is shown in FIG. 12. In this FIG. 12, a photo of the client is shown along with check-in time and the entered comments “Ready for lunch.” The data is then transmitted to central system 50 at step 432 and stored at step 434 to enable the counselor to subsequently review and counsel the client. At step 436, central system 50 will also count the number of check-ins for that client along with any other information about the client check-in as known to those skilled in the art. Check-in count may be used for user support and positive feedback and reinforcement as described below. The client may exit the check-in process at step 438 by activating an interface button or other command as known to those skilled in the art. This may be done for example using the activation button entitled “Done” as shown in FIG. 12.

The process moves to decision step 440 wherein the client is prompted to decide whether he/she wishes to post check-in data to a group of clients that are members of that client's network or therapy group much like friends on Facebook or connections on LinkedIn. This group may be established by the client at several points throughout the process or may be established by the counselor with the client's assistance and authorization. This prompt may come in the form of a box, button (option) or other client interface known to those skilled in the art that enables the client to post and move to another screen or part of the application. If the client decides not to post to the group, the process moves to step 452 as described below. If the client decides to post check-in data, the process moves to step 442 wherein check-in data is posted to the therapy group. The process will move to steps 444 and 446 wherein comments are received and posted by the therapy group members relating to the client's check-in data. Central system 50 will ultimately send the comments to the client at step 448 via a user interface. This can be done via a dedicated application or browser) and/or a message such as an email or text message (SMS). An example of this notification interface is shown in FIG. 13 wherein comments are posted. Examples of comments include “Nice Job on five check-ins” from Bob Lam and “Way to go!” from Steve Joslin. The notification interface may include other information as desired. Client member check-in data for the client's group may be posted, transmitted and shown on the user interface as well. When the client has completed his/her review of the notifications, the client may exit the notification screen by activating an interface button or other command as known to those skilled in the art at step 450. This may be done for example using the activation button entitled “Done” or “Exit.”

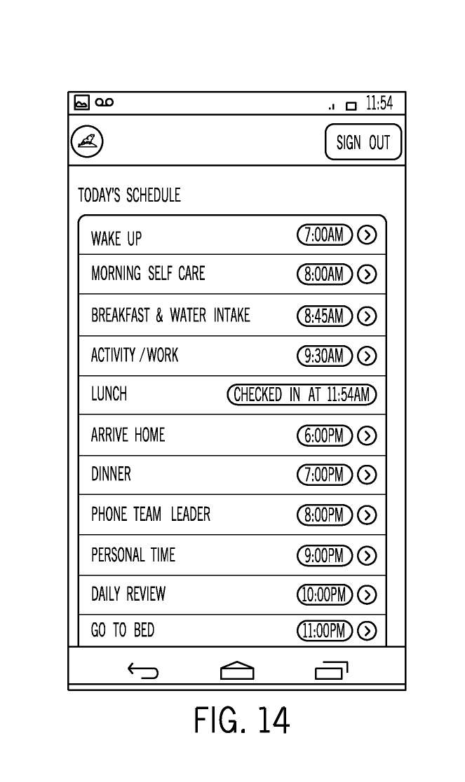

Once the client exits the notification interface, the process then moves to step 452 wherein the client schedule is presented again, but the schedule now includes a check-in notification at the designated time. FIG. 14 depicts an example of the client's schedule showing check-in data at “Lunch.” At this point, the client has a choice whether to continue (decision step 454). If the client does not wish to continue, the client will logoff at step 456 (or automatically be logged off as known to those skilled in the art). If the client does wish to continue, the process moves to decision step 458 wherein the client will decide whether he/she wishes to access client group activity. The client may wish to see the progress of other client members (users) in his peer, i.e., network/therapy group or make comments supporting such members. If the client does not wish to access therapy (peer) group activity, the client will again decide whether to continue at step 454. If he/she wishes to access therapy (peer) group activity, the client will access therapy group activity at step 460 for viewing and commenting and then the process returns to step 454. At varies points in the process, the client may logoff as desired (although not specifically stated above during every step). A counselor is a preferred candidate to lead a therapy group. However, those skilled in the art know that any non-professional may lead the therapy group (e.g., a coach, sponsor, client or other user).

While the process steps are described in the order above, those skilled in the art know that the order may be changed or steps may be added or deleted to achieve the desired outcome as described. In addition, while the process above does not disclose schedule modification, in alternative embodiments, the client (or other user) may be permitted to create or modify the schedule as time progresses with counselor approval.

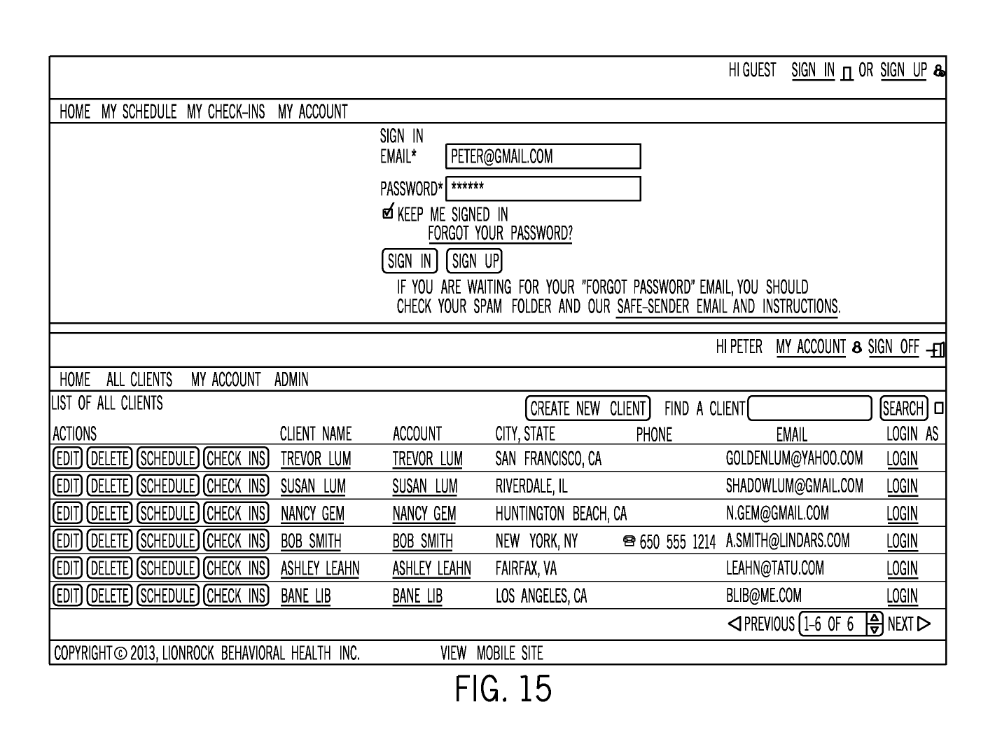

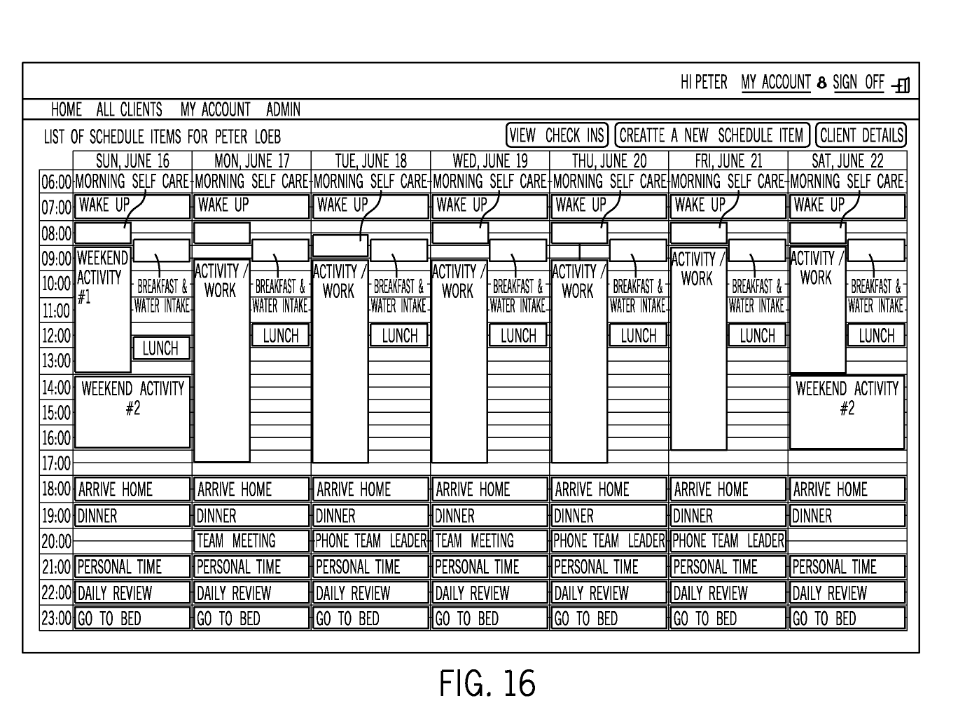

FIG. 5 depicts a flowchart of the application process of the system in FIG. 1 in which a counselor views a client schedule. At step 510, the counselor logins to the system and accesses a list of clients and schedules at step 520. An example of this interface appears in FIG. 15 wherein a list of a clients is associated with web links to access client schedules. The counselor will access and review a specific client weekly schedule at step 530. FIG. 16 depicts and example of client's weekly schedule. In that schedule, the counselor may access and review the daily schedule of the client at step 540. FIG. 17 depicts an example of the client's daily schedule with check-ins.

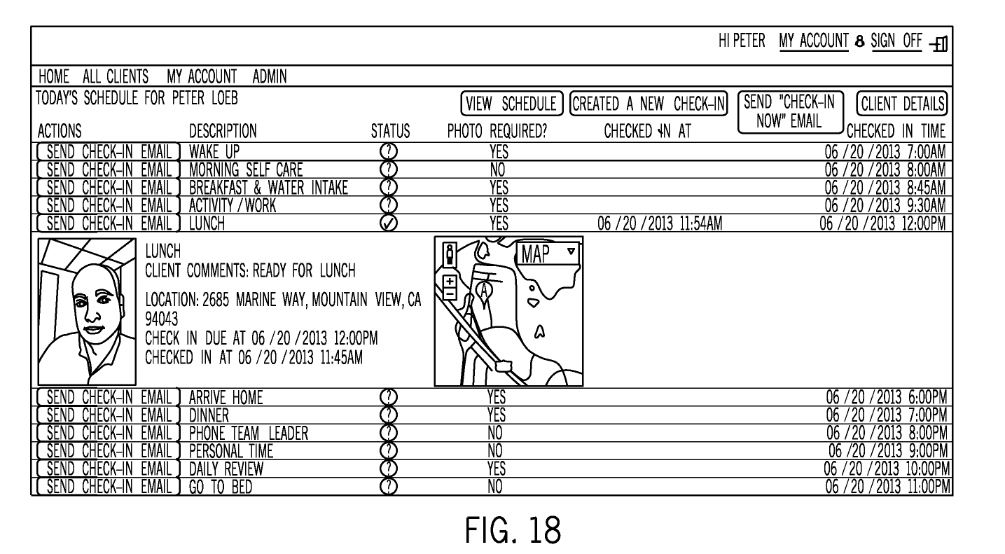

At this point, the client has the choice to access and review a detailed view of a specific client check-in. If the counselor decides to view a specific check-in time at step 550, the counselor will select a check-in detail for viewing at step 560. FIG. 18 depicts a list of check-in times along with an expanded view of the details of a particular check-in (Lunch). Details are presented when the client clicks on the active check-in link to expand such details. The process then moves to decision steps 580 and 590. (Alternatively, these steps may not be employed.) At step 570, the counselor, upon viewing the client's schedule and noticing that the client has not checked-in, has the option to initiate the transmission of a reminder message to the client as described above. If the counselor initiates a check-in reminder message, a message is sent at step 570 and the process returns to step 550. If the counselor does not initiate a message transmission, then the process moves to step 590 wherein the counselor decides whether to create a new check-in time. If so, the new check-in time is created and stored at step 600. Then, the counselor initiates a logoff at step 610. If the client does not wish to create a new check-in time, the client initiates a logoff at step 610.

Now, returning to step 550, if the counselor does not wish to access any client check-in details, the process moves to step 590 wherein the counselor has a choice to create a new check-in time for the client and the process continues as described above.

As described above, a counselor performs tasks in or is involved in one or more steps of processes in FIGS. 3 and 5. However, a counselor is not required for the processes described in this disclosure. Any person may perform the steps or be involved in the processes such as a coach, counselor, sponsor, client or other person/user.

In sum, the application processes of FIGS. 4A-4B and 5 form the application parts of the client engagement platform to assist a client in the compliance of addiction treatment (in addition to databases 50-4, 50-6 and 50-8).

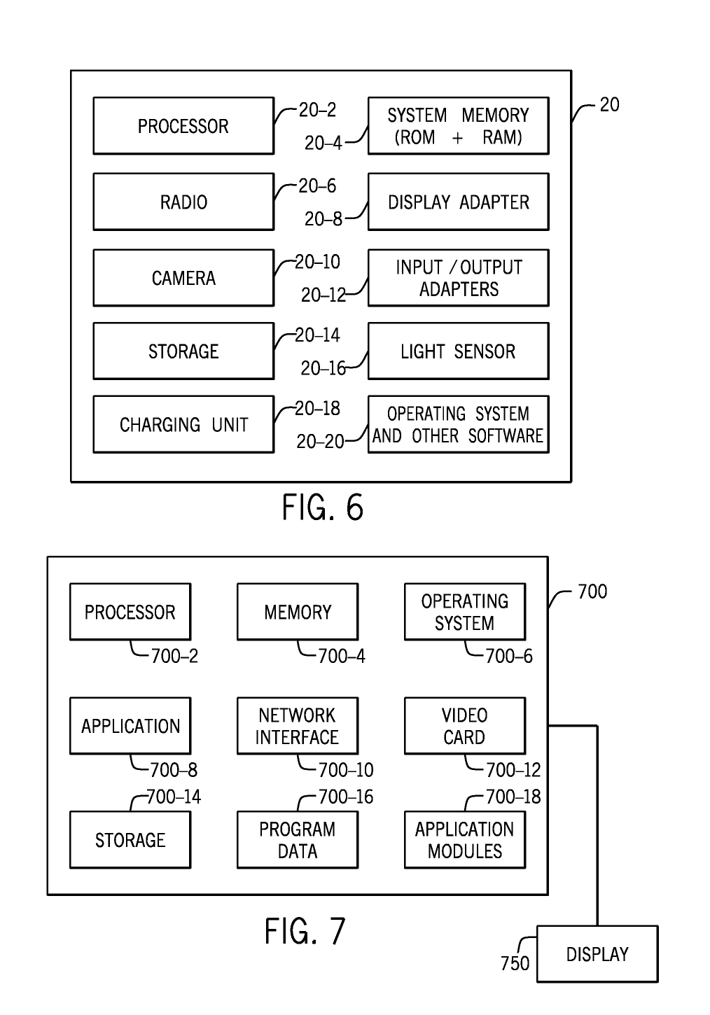

FIG. 6 depicts a block diagram of the components within mobile devices 20 shown in FIG. 1. Mobile device 30 includes similar components so it will not be discussed here. Mobile device 20 preferably incorporates similar conventional components as a personal computer (described below) including a processor, memory, storage and interface devices as known to those skilled in the art. In particular, mobile device 20 incorporates processor 20-2 configured to execute instructions and control other components of mobile device 20 in accordance with such instructions. Mobile device 20 further includes memory 20-4 for storing instructions including volatile and non-volatile memory such as random access memory and read only memory (RAM and ROM).

Mobile device 20 may communicate by wire or wireless means. Wireless communication is achieved by way of radio unit 20-6. Radio unit 20-6 is configured to communicate using radio frequency transmission. Radio unit 20-6 incorporates cellular, WIFI and Bluetooth transceivers for communication as known by those skilled in the art. Mobile device may include a global positioning system (GPS) or such services may be performed using an application for GPS. Mobile device 20 also includes display adapter 20-8 and it is configured to control a display for conveying application process and various activity information, alerts, notifications and the like. Display adapter 20-8 communicates with a display 20-9 and camera 20-10. Mobile device 20 also includes storage 20-14 for storing data and programs as known to those skilled in the art and light sensor 20-16 used to determine a level of brightness for the display for viewing. Device 20 may optionally include input/output adapters 20-12 as known to those skilled in the art. Mobile device 20 also includes a charging unit 20-18 for powering device 20. An accelerometer may optionally be incorporated for detecting movement of mobile device 20. Mobile device 20 may include other sensors as known to those skilled in the art. Mobile device 20 also includes an operating system 20-20 such as iOS, Android or Microsoft Windows Mobile along with other applications including Java etc. as known to those skilled in the art.

FIG. 7 depicts a block diagram of a general-purpose computer to support the embodiments of the computer-implemented systems and methods disclosed herein. In a particular configuration, the computer 700 may be a computer server as described above with respect to the central system 50 or personal computer. (Central system 50 is configured to enable part or all of the process steps of the application (software) in the embodiments described herein. The computer 700 typically includes at least one processor 700-2 and system memory 700-4 (volatile RAM or non-volatile ROM). System memory 700-4 may include computer readable media that is accessible to the processor 700-2. The memory 700-4 may also include instructions from processor 700-2, an operating system 700-6 and one or more application platforms 700-8 such as Java and a part of a software component or one or more software components/applications 700-18. The computer will include one or more communication connections such as network interfaces 700-10 to enable the computer to communication with other computers over a network, storage 700-14 such as a hard drives for storing data 700-16 and other software described above, video cards 700-12 and other conventional components known to those skilled in the art. This computer 700 typically runs Unix or Microsoft as the operating system and include TCP/IP protocol stack (to communicate) for communication over the Internet as known to those skilled in the art. A display 750 is optionally used.

In summary, the system and method disclosed above monitor client activity, location and state of mind. The system and method provide a real time record of (1) what a client is doing, (2) where the client is located and (3) how the client is feeling at various times throughout the day of the client. The system and method provide opportunities for counselors and peers to provide real-time feedback to a client regarding the client's inputs to the system, via a mobile device or personal computer across a network.

A network based system and method are disclosed for behavioral health therapy that uses the capabilities of mobile devices and personal computers to capture client personal data such as personal health status and photographic images including (incorporated or embedded) time, date, and geographic location data and transmit such data securely to a remote central system for the purpose of monitoring client daily activities and compliance with such activities and providing feedback from other clients in the therapeutic group.

Further, the system and method described herein provide therapeutic activity for fostering behavioral change by utilizing a structured plan for each day that guides the client towards desired behaviors and away from destructive behaviors. Specifically, whether in an online or “real space” outpatient setting, a client would create a daily schedule with a counselor and check-in during the day, at appointed times and places, by taking a photo of him/herself using the mobile web site/application. This photo image would include time, date, and location metadata with the image and be uploaded to servers of central system 50 on the on a network accessible by counselors who would compare the image and metadata to the pre-agreed schedule and client profile to ensure compliance. A client will receive feedback directly from other clients who are members of the therapy group. The feedback enhances the therapeutic benefit.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A method for providing a client engagement platform to assist in behavior modification, wherein the method is implemented in a central system programmed to execute the method, the method comprising:
storing, in the central system, a schedule in which one or more designated check-in times are associated with one or more client daily activities; and
receiving, by the central system, a client check-in.

2. The method of claim 1 further comprising monitoring whether the central system has received a client checked-in by a predefined time preceding a designated check-in time of the one or more designated check-in times.

3. The method of claim 2 further comprising sending a check-in reminder message if central system has not received client checked-in by the predefined time.

4. The method of claim 1 wherein the client check-in includes time and/or location of the client.

5. The method of claim 1 wherein the client check-in includes a photo and/or a journal entry.

6. The method of claim 1 further comprising presenting the schedule to the client via a mobile device or personal computer upon a request of the client.

7. The method of claim 3 further comprising storing in the central system the check-in.

8. A computer-implemented system for providing a client engagement platform to assist a client in the compliance of addiction treatment, the system comprising:
a data storage to store:
a client account database, wherein information pertaining to a client is stored in the client account database;
a client schedule database, wherein information pertaining to a schedule of a client is stored in the client schedule database and wherein each schedule includes a plurality of check-in times associated with a plurality of client daily activities; and
one or more servers comprise one or more processors, the one or more processors coupled to the data storage, the one or more processors configured to execute computer program steps, the steps comprising:
monitoring whether the one or more servers has received a client check-in by a predefined time preceding a designated check-in time of the one or more check-in times; and
transmitting a check-in reminder message to the client if the client has not checked-in by the predefined time.

9. The computer-implemented system of claim 8 wherein the steps further comprise sending a check-in reminder message if the one or more servers have not received a client checked-in by the predefined time.

10. The computer-implemented system of claim 8 where the steps further comprise receiving, by the one or more servers, a client check-in.

11. The computer-implemented system of claim 10 wherein the check-in includes a time, photo, geographical location of the client, and/or a journal entry.

12. The computer-implemented of claim 11 further comprising storing in the central system the check-in.

13. The computer-implemented system of claim 8 wherein the steps further comprise presenting the schedule to the client via a mobile device or personal computer upon a request of the client.

14. A computer-implemented system for providing a client engagement platform to assist a client in the compliance of addiction treatment, the system including a central system comprising:
a data storage to store:
a client account database, wherein information pertaining to a client is stored in the client database; and
a client schedule database, wherein information pertaining to a schedule of a client is stored in the client schedule database and wherein each schedule includes a plurality of check-in times associated with a plurality of client daily activities; and
one or more servers coupled to the data storage, wherein the one or more servers comprise one or more processors configured to execute computer program steps, the steps comprising:
receiving a client check-in;
processing the client's check-in; and
storing the client check-in.

15. The system of claim 14 wherein the check-in includes time, photo, date journal entry and/or geographic location of the client at the time of the check-in.

16. The computer-implemented system of claim 14 wherein the steps further comprise presenting advertisements to the client via a mobile device or personal computer related to the client's addiction treatment.

17. A computer-implemented system for providing a client engagement platform to assist a client in the compliance of addiction treatment, the system comprising:
a data storage to store:
a client account database, wherein information pertaining to a plurality of client accounts are stored in the client account database;
a client schedule database, wherein information pertaining to plurality of schedules of a plurality of clients are stored in the client schedule database and wherein each schedule includes a plurality of check-in times associated with a plurality of client daily activities; and
a client group database, wherein information relating to at least one group of clients are stored and wherein clients in the at least one group are associated with each other for support, messaging and/or social networking activities; and
one or more servers coupled to the data storage, wherein the one or more servers comprise one or more processors configured to execute computer program steps, the steps comprising:
receiving a client check-in;
processing the client check-in; and
storing the client check-in.

18. The computer-implemented system of claim 17 wherein the check-in includes time, date photo, journal entry and/or geographic location of the client at the time of the check-in.

19. The computer-implemented system 17 wherein the steps including counting check-ins for a client.

20. The computer implemented system of claim 18 wherein the steps include posting a notification of the client check-in on a social networking website whereby clients with the at least one client group may post comments about the client check-in.

21. A method for providing a client engagement platform to assist a client in the compliance of addiction treatment comprising:
in response to a client request, accessing a client schedule via an application on a computing device, wherein the client schedule being accessed from a central system over a network and wherein the client schedule includes a one or more check-in times associated with a plurality of client daily activities;
initiating a client check-in from the client schedule via the application on the mobile device or a personal computer;
receiving data pertaining to the client check-in by a predefined time within the one or more check-in times via the application on the mobile device or a personal computer; and
sending the data over the network from the mobile device or personal computer to the central system to acknowledge the client check-in.

22. The method of claim 21 wherein the data pertaining to the client check-in includes time, date, photo, journal entry and/or geographic location of the client at the time of the check-in.

23. A computer readable medium storing at least one computer program for providing a client engagement platform to assist a client in the compliance of addiction treatment, the at least one computer program comprising instructions, which when executed by a mobile device or a personal computer, cause the mobile device or personal computer to:
receive data pertaining to the client check-in by a predefined time within the one or more check-in times via the application on the mobile device or a personal computer; and
send the data over the network from the mobile device or personal computer to the central system to acknowledge the client check-in.

24. The method of claim 23 wherein the data pertaining to the client check-in includes time, date, photo, journal entry and/or geographic location of the client at the time of the check-in.
